(19) United States
(12) Patent Application Publication
(10) Pub. No.: US 2025/0273937 A1
(43) Pub. Date: Aug. 28, 2025

(54) Cable Aluminum Foil Layer Processing Device and Method

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Senmiao Hu, Shanghai (CN); Dandan (Emily) Zhang, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/063,406

(22) Filed: Feb. 26, 2025

(30) Foreign Application Priority Data
Feb. 28, 2024 (CN) 202410224212.1

(51) Int. Cl. H02G 1/12; B23K 26/38

(52) U.S. Cl. CPC H02G 1/128; B23K 26/38

(57) ABSTRACT

A cable aluminum foil layer processing device includes a cable clamp, a rotating frame, a laser generator, and a mirror. The cable clamp clamps and fixes a cable having a core wire wrapped by an aluminum foil layer. The rotating frame rotates around a rotation axis that coincides with an axis of the clamped cable. The laser generator installed on the rotating frame emits a laser beam. The mirror on the rotating frame reflects the laser beam onto the aluminum foil layer to cut the aluminum foil layer. During the cutting of the aluminum foil layer the rotating frame rotates once around the rotation axis to cut a cut line along a circumferential direction of the aluminum foil layer. A cutting depth of the laser beam is equal to or less than a thickness of the aluminum foil preventing the laser beam from cutting the core wire.

### CROSS-REFERENCE TO RELATED APPLICATION

This application claims the benefit of the filing date under 35 U.S.C. § 119 (a)-(d) of Chinese Patent Application No. CN202410224212.1 filed on Feb. 28, 2024.

### FIELD OF THE INVENTION

The present invention relates to a cable aluminum foil layer processing device and a method for processing an aluminum foil layer of a cable using the cable aluminum foil layer processing device.

### BACKGROUND OF THE INVENTION

When connecting a cable, it is necessary to remove the aluminum foil layer from one end of the cable. The aluminum foil layer is wrapped around the core wire of the cable to provide electromagnetic shielding. For a single core cable with a single core wire, the outer contour of the aluminum foil layer wrapped around the single core wire is circular, so the aluminum foil layer can be cut by rotating the blade. However, for a multi-core cable with multiple core wires, the outer contour of the aluminum foil layer wrapped around the multiple core wires is non-circular, which makes it impossible to use a rotating blade to cut the aluminum foil layer; thus, only manual methods can be used to cut the aluminum foil layer. However, the efficiency of manually cutting aluminum foil layers is very low, and the cutting depth is difficult to control, making it easy to cut to the core wire.

### SUMMARY OF THE INVENTION

A cable aluminum foil layer processing device includes a cable clamp, a rotating frame, a laser generator, and a mirror. The cable clamp clamps and fixes a cable having a core wire wrapped by an aluminum foil layer. The rotating frame rotates around a rotation axis that coincides with an axis of the clamped cable. The laser generator installed on the rotating frame emits a laser beam. The mirror on the rotating frame reflects the laser beam onto the aluminum foil layer to cut the aluminum foil layer. During the cutting of the aluminum foil layer the rotating frame rotates once around the rotation axis to cut a circle along a circumferential direction of the aluminum foil layer. A cutting depth of the laser beam is equal to or less than a thickness of the aluminum foil layer to prevent the laser beam from cutting the core wire.

### BRIEF DESCRIPTION OF THE DRAWINGS

The invention will now be described by way of example with reference to the accompanying figures, of which:

FIG. 1 is a perspective view of a dual core cable;

FIG. 2 is a perspective view of a three-core cable;

FIG. 3 is a perspective view of another type of dual core cable;

FIG. 4 is a perspective view of a dual core cable having an aluminum foil layer wrapped around two core wires;

FIG. 5 is a side view of a cable aluminum foil layer cutting device and a multi-core cable according to an exemplary embodiment;

FIG. 6 is a side view of cutting a cut line on an aluminum foil layer of the multi-core cable of FIG. 5 using the cable aluminum foil layer cutting device of FIG. 5;

FIG. 7 is a perspective view of the multi-core cable of FIG. 5 after being cut by the cable aluminum foil layer cutting device of FIG. 5;

FIG. 8 is a side view of a gripper according to an exemplary embodiment clamping and grasping the cut aluminum foil layer of the multi-core cable of FIG. 5;

FIG. 9 is a side view of the gripper of FIG. 8 pulling and beginning to separate the cut aluminum foil layer from the multi-core cable of FIG. 5;

FIG. 10 is a perspective view of the cut aluminum foil layer beginning to separate from the multi-core cable of FIG. 5;

FIG. 11 is the view of FIG. 9 after the gripper of FIG. 8 pulls the aluminum foil layer off of the multi-core cable of FIG. 5; and

FIG. 12 is a perspective view of the cut aluminum foil layer separated from the multi-core cable of FIG. 5.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

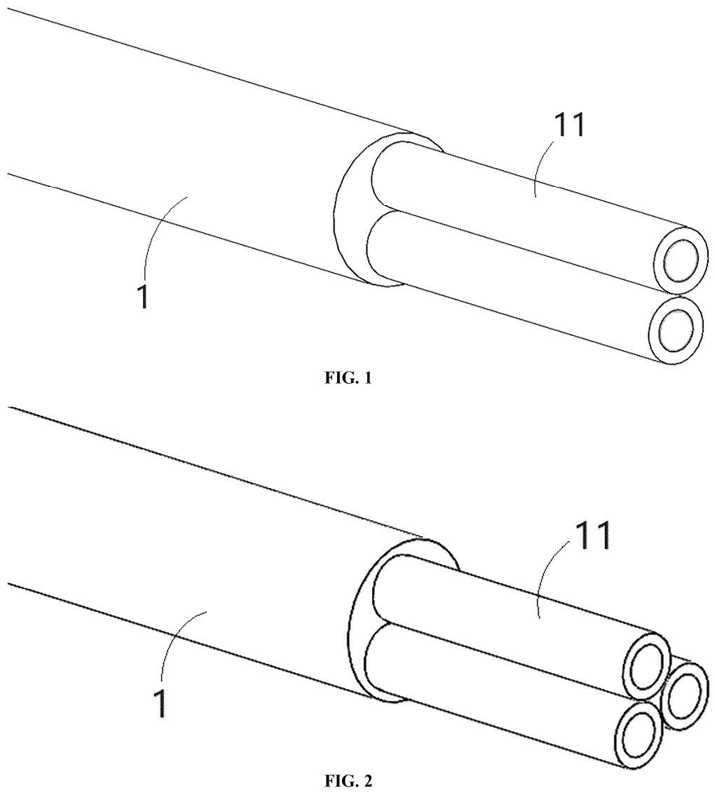

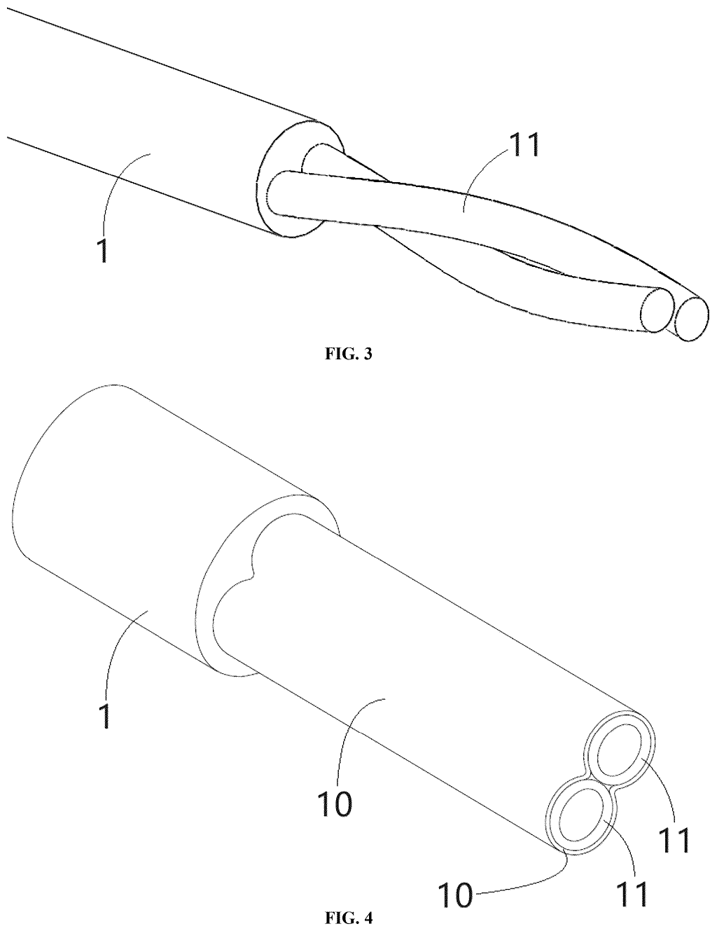

As shown in FIGS. 1-4, various cables 1 having various numbers of core wires 11 covered by an aluminum foil layer 10 are disclosed. For the multi-core cables 1, the outer contour of the aluminum foil layer 10 wrapped around multiple core wires 11 is non-circular. Therefore, the existing method of rotating a blade around the aluminum foil layer 10 cannot be used to cut the aluminum foil layer 10.

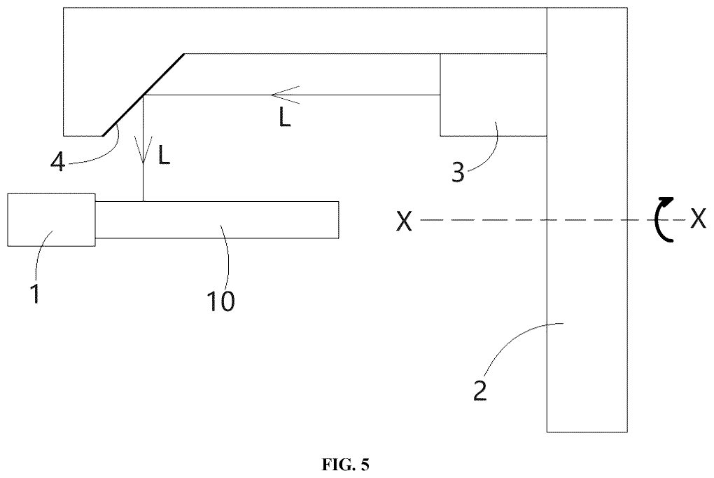

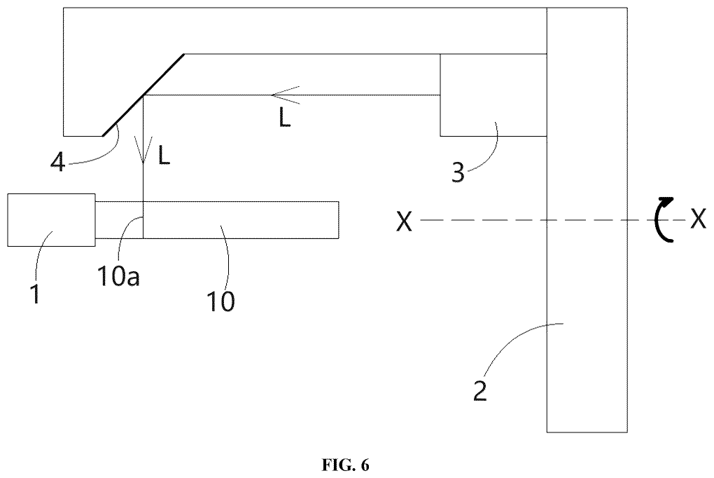

A cable aluminum foil layer processing device according to an exemplary embodiment as shown in FIGS. 5-6 is now described. The cable aluminum foil layer processing device comprises a cable clamp, a rotating frame 2, a laser generator 3, and a mirror 4. The cable clamp is used to clamp and secure the cable 1. The rotating frame 2 can rotate around a rotation axis X that coincides with the axis of the clamped cable 1. The laser generator 3 is installed on the rotating frame 2. The laser generator 3 emits a laser beam L. The mirror 4 is provided on the rotating frame 2 to reflect the laser beam L onto the exposed aluminum foil layer 10 of cable 1, in order to cut the aluminum foil layer 10.

The cable aluminum foil layer processing device can cut and remove the aluminum foil layer 10 of the multi-core cable 1 with multiple core wires 11, such as the dual core cable shown in FIGS. 1, and 3-5, or the three-core cable shown in FIG. 2. The cable aluminum foil layer processing device can also be used for cutting and removing the aluminum foil layer 10 of a single core cable 1 with a single core wire 11.

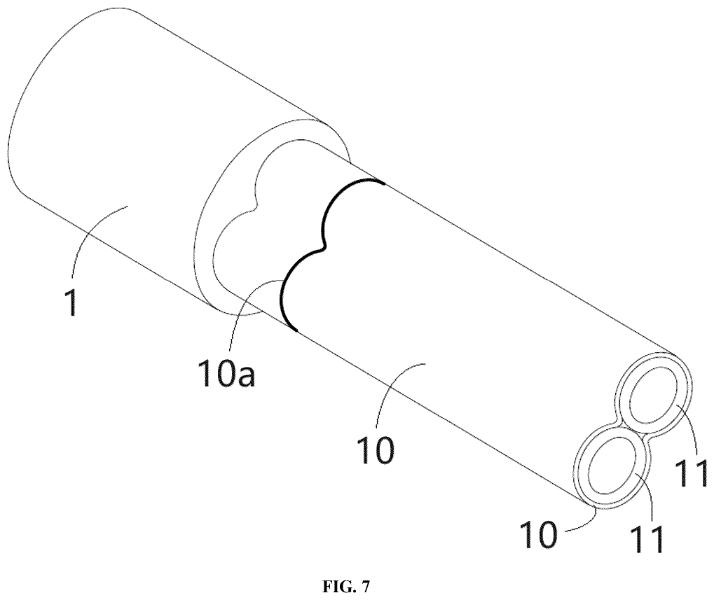

As shown in FIGS. 5-6, during the process of cutting the aluminum foil layer 10, the rotating frame 2 rotates once around the rotation axis X to cut a non-circular cut line 10a along the circumferential direction of the aluminum foil layer 10 of the multi-core cable 1 by the laser beam L. For example, FIG. 7 shows the multi-core cable 1 with multiple core wires 11 and the aluminum foil layer 10 after the cable aluminum foil layer processing device cuts the non-circular shape at the cut line 10a along the circumferential direction of the aluminum foil layer 10 of the multi-core cable 1. The rotating frame 2 also rotates once around the rotation axis X when cutting a circular cut line 10a along a circumferential direction of the aluminum foil layers 10 of the single core cable 1.

The cutting depth of the laser beam Lis set to be equal to or slightly less than the thickness of the aluminum foil layer 10 to prevent the laser beam L from cutting the core wire 11 of the cable 1 wrapped by the aluminum foil layer 10. The power and/or focusing diameter of the laser beam L emitted by the laser generator 3 can be adjusted to adjust the cutting depth of the laser beam L. In this way, it is possible to cut aluminum foil layers of different thicknesses, expanding the application range of the cable aluminum foil layer cutting device.

The rotational speed of the rotating frame 2 can be adjusted to enable the cutting speed and cutting depth of the laser beam L to be adjusted. In this way, aluminum foil layers of different thicknesses can be cut at different speeds, expanding the application range of the cable aluminum foil layer cutting device.

As shown in FIGS. 5-6, the laser beam Lis directed towards the center of the cable 1 after being reflected by the mirror 4 and travels in a direction perpendicular to the rotation axis X of the rotating frame 2. The laser beam L travels in a direction parallel to the rotation axis X of the rotating frame 2 before being reflected by the mirror 4.

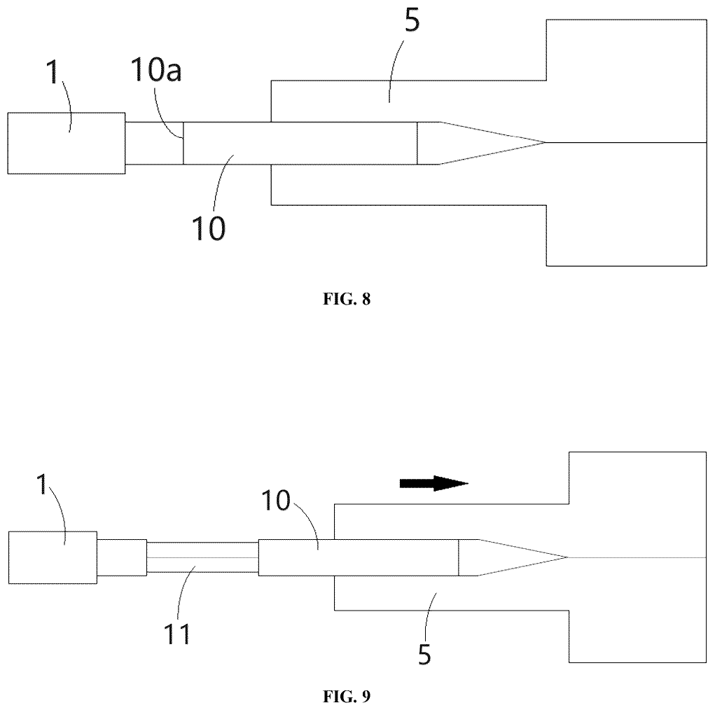

As shown in FIGS. 8-9, the cable aluminum foil layer processing device further comprises a gripper 5. The gripper 5 is used to grab and pull the cut aluminum foil layer 10 to remove it from the cable 1. For example, the gripper 5, as shown in FIG. 11, is shown after removing the cable aluminum foil layer 10 off of the multi-core cable 1 with multiple core wires 11. In an exemplary embodiment of the present invention, the gripper may be a robotic arm mounted on a robot. The gripper 5 can twist left and right around the axis of the cable 1 and can move along the axial direction of the cable 1 to pull the cut aluminum foil layer 10 off the cable 1.

In the aforementioned exemplary embodiments according to the present invention, the cable aluminum foil layer processing device is capable of automatically cutting and removing the aluminum foil layer 10, thereby improving the processing efficiency of removing the aluminum foil layer 10 without cutting the core wire(s) 11 of the cable 1.

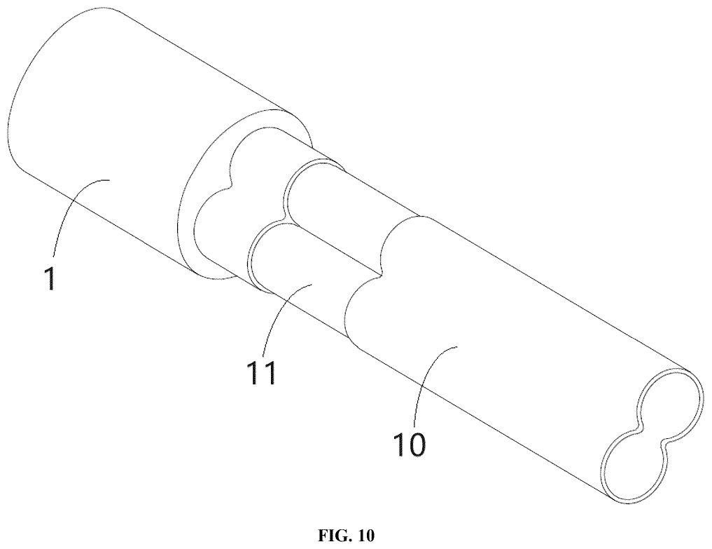

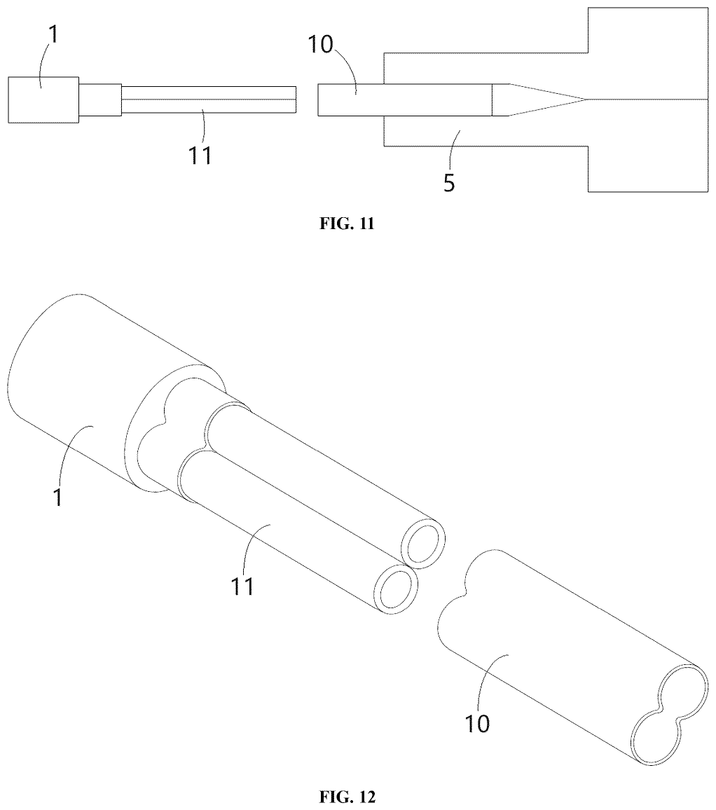

A cable aluminum foil layer processing method according to an exemplary embodiment as shown in FIGS. 4-12 is now described. The method for processing the aluminum foil layer of the cable includes a step S10, a step S20, and a step S30. The step S10 is providing the aforementioned cable aluminum foil layer processing device. The step S20 is clamping the cable 1 by the cable clamp. The step S30 is driving the rotating frame 2 to rotate and activate the laser generator 3 to emit a laser beam L, in order to cut a circle along the circumferential direction of the exposed aluminum foil layer 10 of the cable 1 through the laser beam L.

As shown in FIGS. 6-12, the method for processing the aluminum foil layer of the cable further includes a following step S40. The step S40 is using the gripper 5 to grab and pull the cut aluminum foil layer 10 to remove it from the cable 1.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A cable aluminum foil layer processing device, comprising:
a cable clamp clamping and fixing a cable having a core wire wrapped by an aluminum foil layer;
a rotating frame rotating around a rotation axis that coincides with an axis of the clamped cable;
a laser generator installed on the rotating frame and emitting a laser beam;
a mirror on the rotating frame reflecting the laser beam onto the aluminum foil layer to cut the aluminum foil layer, during the cutting of the aluminum foil layer the rotating frame rotates once around the rotation axis to cut a cut line along a circumferential direction of the aluminum foil layer, a cutting depth of the laser beam is equal to or less than a thickness of the aluminum foil layer.

2. The cable aluminum foil layer processing device of claim 1, wherein a power of the laser beam emitted by the laser generator is adjustable to adjust the cutting depth of the laser beam.

3. The cable aluminum foil layer processing device of claim 1, wherein a focusing diameter of the laser beam emitted by the laser generator is adjustable to adjust the cutting depth of the laser beam.

4. The cable aluminum foil layer processing device of claim 1, wherein a rotational speed of the rotating frame is adjustable to adjust a cutting speed and a cutting depth of the laser beam.

5. The cable aluminum foil layer processing device of claim 2, wherein a rotational speed of the rotating frame is adjustable to adjust a cutting speed and a cutting depth of the laser beam.

6. The cable aluminum foil layer processing device of claim 3, wherein a rotational speed of the rotating frame is adjustable to adjust a cutting speed and a cutting depth of the laser beam.

7. The cable aluminum foil layer processing device of claim 1, wherein the laser beam is directed towards a center of the cable after being reflected by the mirror and travels in a direction perpendicular to the rotation axis of the rotating frame.

8. The cable aluminum foil layer processing device of claim 7, wherein the laser beam travels in a direction parallel to the rotation axis of the rotating frame before being reflected by the mirror.

9. The cable aluminum foil layer processing device of claim 1, further comprising a gripper grabbing and pulling the cut aluminum foil layer to remove it from the cable.

10. The cable aluminum foil layer processing device of claim 9, wherein the gripper twists left and right around the axis of the cable and moves along an axial direction of the cable to pull the cut aluminum foil layer off the cable.

11. The cable aluminum foil layer processing device of claim 10, wherein the gripper is a robotic arm installed on a robot.

12. The cable aluminum foil layer processing device of claim 1, wherein the cable aluminum foil layer processing device cuts and removes an aluminum foil layer of a cable having a plurality of core wires.

13. A method for cutting a profile of varying depth in an aluminum foil layer of a cable, comprising:
positioning the cable;
clamping the cable to secure it in a position;
reflecting a laser beam onto the aluminum foil layer; and
rotating the laser beam once around a rotation axis that coincides with an axis of the clamped cable to cut the aluminum foil layer.

14. The method of claim 13, further comprising using a gripper to grab and pull the cut aluminum foil layer off of the cable.

15. The method of claim 13, wherein the laser cuts a circular at a cut line along a circumferential direction of the aluminum foil layer.

16. The method of claim 13, wherein the laser cuts a non-circular cut line along a circumferential direction of the aluminum foil layer.

17. The method of claim 13, further comprising activating the laser beam by driving a rotating frame to rotate around the rotation axis.

18. The method of claim 13, further comprising adjusting a rotational speed of the laser beam to adjust a cutting speed and a cutting depth of the laser beam.

19. The method of claim 18, wherein the rotational speed of the laser beam is adjusted by adjusting the rotational speed of a rotating frame.
